(19) United States
(12) Patent Application Publication
(10) Pub. No.: US 2014/0310304 A1
(43) Pub. Date: Oct. 16, 2014

(54) SYSTEM AND METHOD FOR PROVIDING FASHION RECOMMENDATIONS

(71) Applicants: Anurag Bhardwaj, Sunnyvale, CA (US); Wei Di, San Jose, CA (US); Vignesh Jagadeesh, Goleta, CA (US); Robinson Piramuthu, Oakland, CA (US); Neelakantan Sundaresan, Mountain View, CA (US)

(72) Inventors: Anurag Bhardwaj, Sunnyvale, CA (US); Wei Di, San Jose, CA (US); Vignesh Jagadeesh, Goleta, CA (US); Robinson Piramuthu, Oakland, CA (US); Neelakantan Sundaresan, Mountain View, CA (US)

(73) Assignee: EBAY INC., SAN JOSE, CA (US)

(21) Appl. No.: 14/109,516

(22) Filed: Dec. 17, 2013

Related U.S. Application Data
(60) Provisional application No. 61/811,423, filed on Apr. 12, 2013.

(51) Int. Cl. G06F 17/30

(52) U.S. Cl. CPC G06F 17/30277; G06F 17/30864
USPC 707/769

(57) ABSTRACT

Providing fashion recommendations based on an image of clothing. Color, pattern, and/or style information corresponding to the clothing may be identified and used to find relevant clothing and/or accessories in an inventory to recommend to a user. The image may be a video of clothing and/or accessories on a human body in motion. An area thereof may be sampled, detected and tracked across sequential frames of the video to obtain color, pattern, and/or style information which may be compared against clothing and/or accessories in an inventory to provide real-time (or near real-time) recommendations to the user. The image may comprise clothing of interest that is associated with a celebrity. The celebrity may be specified and the system returns recommendations of items in the inventory that are matching or complementary to the clothing/accessory of interest and which are consistent with the particular celebrity's fashion style.

### RELATED APPLICATION

This application claims the benefit of priority of U.S. Provisional Application Ser. No. 61/811,423, filed on Apr. 12, 2013, which is incorporated herein by reference in its entirety.

### TECHNICAL FIELD

The present invention relates generally to image recognition and uses of image data obtained from image recognition to recommend clothing, accessories, or wearable items.

### BACKGROUND

Images can be used to convey information more efficiently or in a way that is difficult, or perhaps not possible, with text, particularly from the viewpoint of a user viewing the images or to facilitate electronic commerce (e-commerce).

### BRIEF DESCRIPTION OF THE DRAWINGS

Some embodiments are illustrated by way of example and not limitations in the figures of the accompanying drawings, in which:

FIG. 1 illustrates a block diagram depicting a network architecture of a system, according to some embodiments, having a client-server architecture configured for exchanging data over a network.

FIG. 2 illustrates a block diagram showing components provided within the system of FIG. 1 according to example embodiments.

FIG. 3 illustrates various wardrobes using edge detection to parse the wardrobes into component parts according to some embodiments.

FIG. 4 is a flowchart for making recommendations according to an example embodiment.

FIG. 5 is a flowchart of object detection according to an example embodiment.

FIG. 6 is a flowchart of a worker thread according to an example embodiment.

FIG. 7 is a screen shot of a single frame from a video stream according to an example embodiment.

FIG. 8 is a screen shot of a single frame with detection rectangles according to an example embodiment.

FIG. 9 is a screen shot of a single frame with a sampling rectangle and a tracking rectangle according to an example embodiment.

FIG. 10 is an illustration of recommended items based on color distribution according to an example embodiment.

FIG. 11 is an illustration of frames of a video stream with cropping based on a detection rectangle according to an example embodiment.

FIG. 12 is an illustration of tagged fusion items according to an example embodiment.

FIG. 13 is a flow chart for providing celebrity inspired recommendations according to an example embodiment.

FIG. 14 is an illustration of screen shots for enabling users to browse results for different celebrities according to an example embodiment.

FIG. 15 is an illustration of a retrieved result for a selected item, according to an example embodiment.

FIG. 16 is an illustration of a user interface for browsing recommendations for a first celebrity according to an example embodiment.

FIG. 17 illustrates a diagrammatic representation of a machine in the example form of a computer system within which a set of instructions may be executed to cause the machine to perform any one or more of the methodologies discussed herein.

The headings provided herein are for convenience only and do not necessarily affect the scope or meaning of the terms used.

### DESCRIPTION

Described in detail herein is an apparatus and method for providing recommendations of clothing and/or accessories based on a query image. In one embodiment, the query image comprises the contents of a user's wardrobe or closet. Color, pattern, and/or style information about the user's wardrobe contents may be determined. Clothing and/or accessories available in an inventory of an e-commerce site or online marketplace that may be relevant to the user's wardrobe contents (e.g., similar, complementary) may be presented as fashion recommendations to the user. In order to use images based on the wealth of information contained therein, image processing may be performed to extract, identify, or otherwise recognize attributes of the images. Once extracted, the image data can be used in a variety of applications. Depending on the particular application(s), certain types of image processing may be implemented over others. Determined image attributes may be used to identify relevant goods or services for presentation to users.

In another embodiment, the query image comprises a video that includes clothing and/or accessories content. In an embodiment, “relevant” may be viewed as meaning an exact match of an item, or a similar, or a complementary item, to a query or context. In one embodiment, a system may recommend an exact (or nearly exact) matching skirt to, or a similar skirt to, or a top that goes well with, a skirt, that is in or associated with a query. Stated another way, “relevant” may be viewed as meaning relevant to a query or context. Further, “context” may be viewed as meaning information surrounding an image. In one embodiment, if a user is reading a blog that contains an image, context may be extracted from the caption or surrounding text.

In one embodiment, detection and tracking of a human body may be performed across sequential frames of the video. Based on such detection and tracking, clothing/accessories worn on the human body may also be detected and tracked. A sampling of the tracked clothing/accessories may be taken to obtain color, pattern, and/or style information. Real-time or near real-time recommendations of relevant inventory items may be provided to the user. In some cases, a summary of the recommendations corresponding to each of the tracked clothing/accessories for a given video may also be provided to the user, to take into account the possibility that the user may be focusing more on watching the rest of the video rather than recommendations that are presented corresponding to an earlier portion of the video. In another embodiment, the query image comprises a user-uploaded image that includes clothing or accessories. The user may identify the clothing/accessory within the image that is of interest. The user may also identify a celebrity whose fashion style he/she would like to emulate in an item that would be complementary to the identified clothing/accessory of interest. The system returns recommendations of items in the inventory that may be complementary to the clothing/accessory of interest and which are consistent with the particular chosen celebrity's fashion style.

Various modifications to the example embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that the invention may be practiced without the use of these specific details. In other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

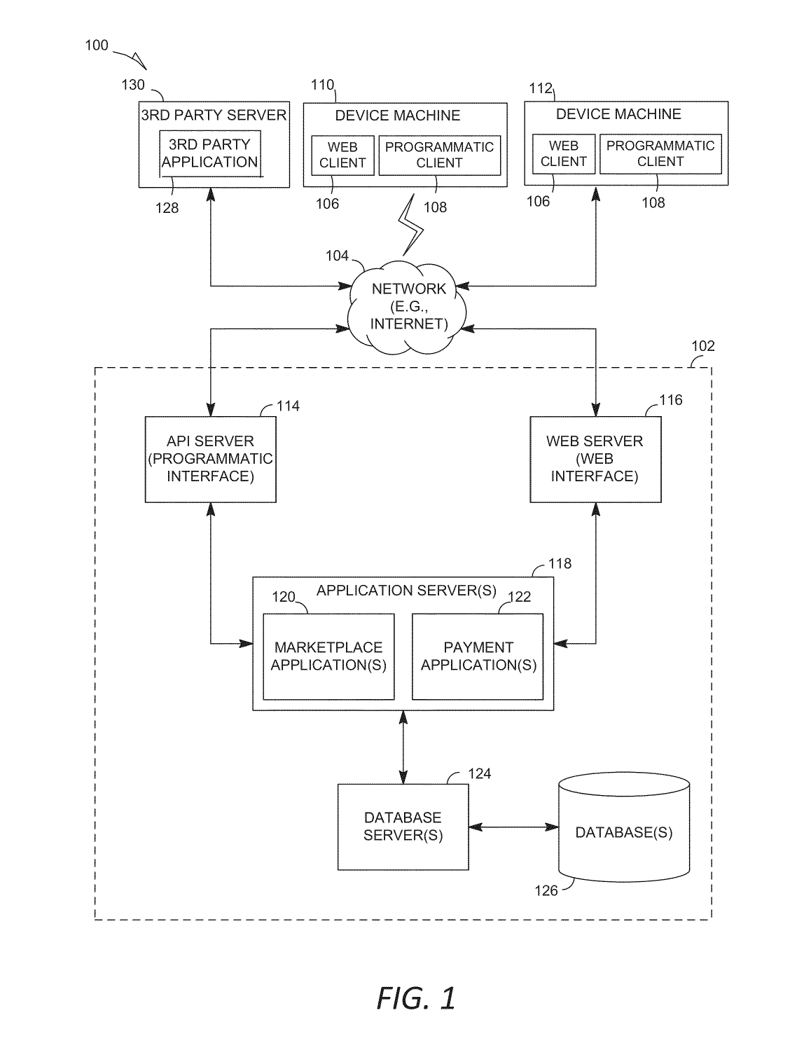

FIG. 1 illustrates a network diagram depicting a network system 100, according to one embodiment, having a client-server architecture configured for exchanging data over a network. A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on device machines 110 and 112. In one embodiment, the publication system 100 comprises a marketplace system. In another embodiment, the publication system 100 comprises other types of systems such as, but not limited to, a social networking system, a matching system, a recommendation system, an electronic commerce (e-commerce) system, a search system, and the like.

Each of the device machines 110, 112 comprises a computing device that includes at least a display and communication capabilities with the network 104 to access the networked system 102. The device machines 110, 112 comprise, but are not limited to, remote devices, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the device machines 110, 112 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the device machines 110, 112 includes one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the device machines 110, 112, then this application is configured to locally provide the user interface and at least some of the functionalities with the application configured to communicate with the networked system 102, on an as needed basis, for data and/or processing capabilities not locally available (such as access to a database of items available for sale, to authenticate a user, to verify a method of payment, etc.). Conversely if the e-commerce site application is not included in a given one of the device machines 110, 112, the given one of the device machines 110, 112 may use its web browser to access the e-commerce site (or a variant thereof) hosted on the networked system 102. Although two device machines 110, 112 are shown in FIG. 1, more or less than two device machines can be included in the system 100.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of e-commerce functions and services to users that access networked system 102. E-commerce functions/services may include a number of publisher functions and services (e.g., search, listing, content viewing, payment, etc.). For example, the marketplace applications 120 may provide a number of services and functions to users for listing goods and/or services or offers for goods and/or services for sale, searching for goods and services, facilitating transactions, and reviewing and providing feedback about transactions and associated users. Additionally, the marketplace applications 120 may track and store data and metadata relating to listings, transactions, and user interactions. In some embodiments, the marketplace applications 120 may publish or otherwise provide access to content items stored in application servers 118 or databases 126 accessible to the application servers 118 and/or the database servers 124. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the system 100. In some embodiments, at least a portion of the marketplace applications 120 may be provided on the device machines 110 and/or 112.

Further, while the system 100 shown in FIG. 1 employs a client-server architecture, embodiments of the present disclosure is not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

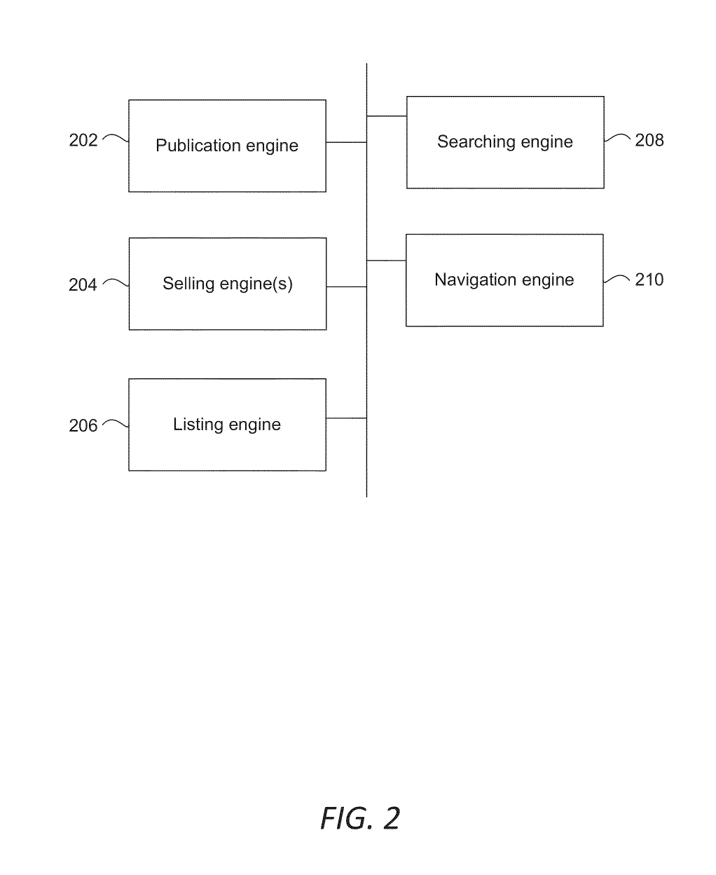

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations, selections, or click-throughs).

The searching engine 208 also may perform a search based on a location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

Additional modules and engines associated with the networked system 102 are described below in further detail. It should be appreciated that modules or engines may embody various aspects of the details described below. In one embodiment, clothing items may be recommended based on a user's wardrobe content. In another embodiment, recommendations can be based on similar items or complementary items or based on need for diversity. In another embodiment, recommendations can be made based on virtual wardrobes created from a collection of clothes a celebrity or a person in the social network wore in public.

Wardrobe Based Recommendations

In one embodiment, a wardrobe engine or wardrobe recommendation engine (and/or one or more other modules) may be included in the networked system 102 or client machines 110, 112 to perform the functions and operations described below. Clothes, accessories, and/or wearable items owned by a person, which may be stored in a wardrobe, closet, dresser, or other container for holding clothing, may indicate the person's fashion inclinations. It may be a reflection of a person's choice of style, colors, and patterns for fashion. For example: Does the person have formal clothing? How much of it is formal? Are there bright colors? Are there a lot of plaids? Are there any jeans or skirts or coats/jackets? What percent are for top wear? Do they have only a limited set of colors? Such questions can be answered and used for recommending new clothes or fashion styles to the person. Lack of blue jeans may imply that the person has limited informal clothing in the wardrobe. Mostly dark colored clothing may imply formal clothes. Mostly solid colored clothes may imply formal clothes. Checkered patterns or plaids may be considered less formal than floral patterns. Varying heights of clothing in a wardrobe imply varying styles. Wide difference between shortest and longest clothing may imply presence of skirts. Color biases can also indicate a wearer's gender. Thicker clothing (from the side view) may imply coats. Pants, trousers, and coats are heavier and firmer than shirts or blouses, and hence such heavier articles of clothing may hang flatter and straighter. Such information can be used to recommend clothing items.

In one embodiment, boundary detection and sampling may be used to recommend clothing items based on a person's wardrobe content. Sample swatches from clothing items may be taken while background information may be avoided (or filtered out) using a swatch extraction module as discussed in the above referenced U.S. patent application. Global statistics may be obtained by extracting at least a swatch across all clothing items. If boundary detection is found not to be reliable for the particular wardrobe content, region segmentation or clustering of local color distribution may alternatively be used.

In one embodiment it may be assumed that the wardrobe contains all of the person's clothes and that they are all hanging from clothes hangers. It is also assumed that the wardrobe contains only one main bar where the clothes hang from. Clothes are assumed to hang from hangers. Accordingly, non-hanging clothes, such as clothing provided on shelves, may not be considered. Such assumptions may be relaxed by requesting the user to mark the rectangular region where the clothes may be sampled from. It is also assumed in one embodiment that the orientation of the wardrobe/closet is vertical in the picture/image of the wardrobe (as opposed to rotated sideways or diagonally or upside down), and that the image shows the side profile of clothes in the wardrobe. These assumptions help to simplify the automatic discovery and recommendation process.

The following observations or rules may be used:
Clothes hangers have a short vertical piece at the top, referred to as the neck.
Most of the clothes expose the neck of clothes hangers.
Furry coats usually occlude the neck of clothes hangers.
Dissimilar clothes have an obvious boundary between them.
Boundaries between clothes are more vertical and straight when the clothing is heavy or firm. This is true for coats, jackets, trousers, jeans, denim, and leather.
Height of the side profile of clothes is proportional to the length of clothing.
Trousers may be folded and then hung.
Coats & jackets are usually thicker and wider side profile) than other clothing types.
   The above set of rules may be used to roughly classify clothes based on height and thickness.

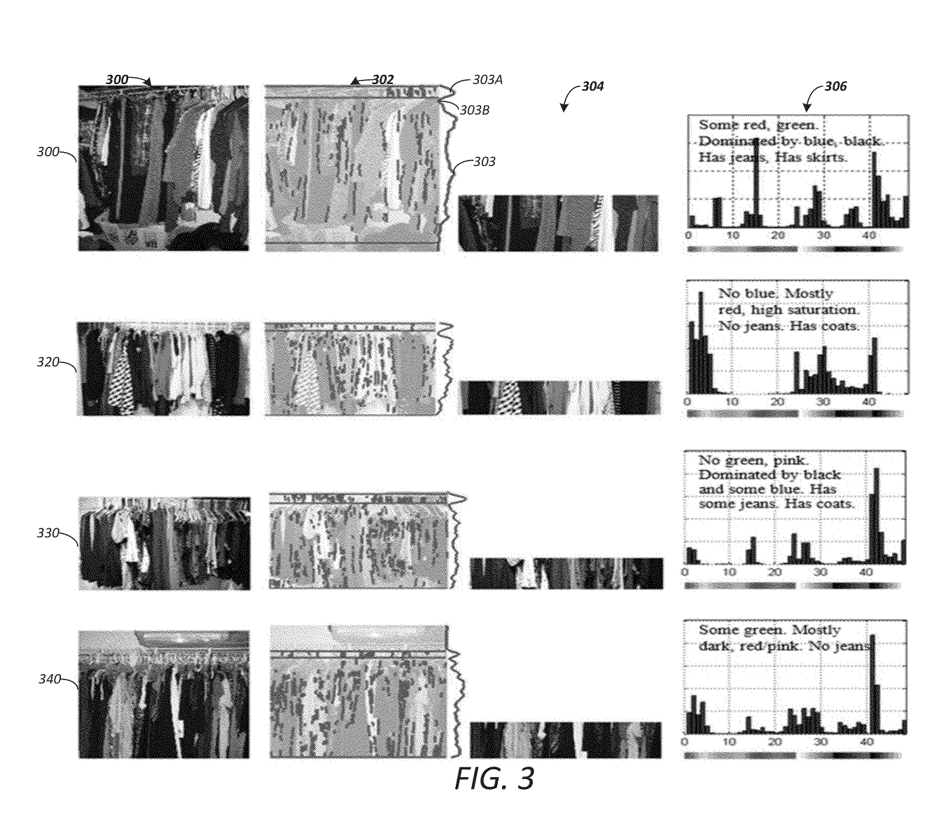

Luminance image from a red/green/blue (RGB) image of a user's wardrobe content may be extracted by taking the average of the three color channels. The luminance image may then be enhanced using adaptive histogram equalization. Adaptive histogram equalization stretches the histogram by maintaining its salient shape properties. An edge map may then be extracted using a standard Canny edge detector. Canny edge detector uses two thresholds. The high threshold may be chosen so that 70% of the pixels with low gradient magnitude are below that threshold. The low threshold may be chosen to be 40% of the high threshold. Optionally, this edge map may be generated from all color channels and then merged before non-maximum suppression. The edge map may have junctions where multiple edges meet. This may be broken by applying a 3×3 box filter across the edge map and then eliminating those pixels that have more than 3 edge pixels in the 3×3 neighborhood. This break up of edges helps in estimating the orientation and length more easily. Connected components from the resulting edge map may be obtained and, in one embodiment, only those edge regions large enough and oriented almost vertically may be kept. This will give an edge map with almost vertical lines. We use the absolute orientation range of 80°-90° to define vertical lines. This is illustrated in FIG. 3 for four different wardrobes, 300, 320, 330, and 340. For a more detailed written description of the technology described herein, the reader is referred to United States Patent Application Publication 2013/0085893, Ser. No. 13/631,848, entitled Acquisition and Use of Query Images with Image Feature Data, filed Sep. 28, 2012 and incorporated herein by reference in its entirety.

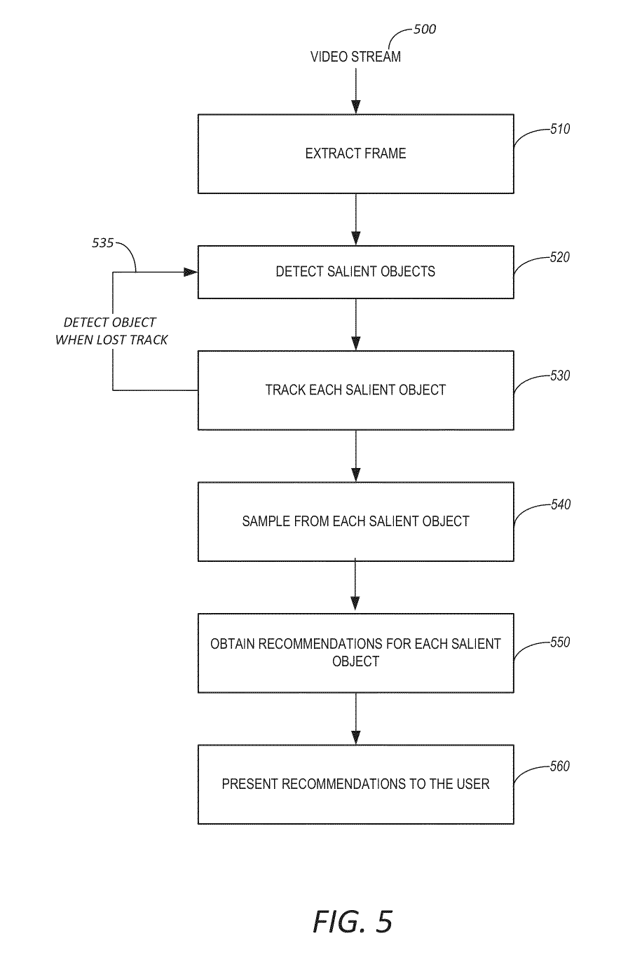

In FIG. 3, the first (leftmost) column 300 shows images taken of a user's wardrobe content (such as photos taken by a user's device, e.g., smart phone, tablet, and the like). The second column 302 shows the resulting edge mapping of the respective images in the first column, obtained in one embodiment by using a Canny edge detector as discussed above. The edge map may be then projected along the horizontal axis of an image. In other words, a row sum of the edge map is taken. This is illustrated in blue at 303 of FIG. 3, to the right of the edge map 302. Notice the shape of the row profile. The first major bump 303A is due to the necks of clothes hangers. The bottom end 303B of this bump is treated as the beginning of where the clothes are located. The row profile may be similarly used to estimate the bottom of the longest clothes. This information may be used to extract the rectangular sample (middle third of the image), as illustrated in the third column 304 of FIG. 3 for the four different wardrobes 300, 320, 330, and 340. A color histogram may be extracted from this sample and is shown in the rightmost column 306 of FIG. 3. As shown just below the horizontal axis, the color histogram has 4 parts: hue, saturation, and value for color pixels and brightness of gray pixels, with, in one embodiment, 8, 8, and 8 uniform bins, respectively, much like FIG. 5G of U.S. patent application Ser. No. 13/631,848 referenced above. Each group of the color histogram may be also weighted by a factor of 0.4, 0.2, 0.1, and 0.3 respectively. This weighted color histogram comprises a color signature. Signature pattern may be used to augment the color signature. It may not be very effective to use just pattern signature since the profile view of clothing may not capture sufficient information about patterns. For example, the design print on the front of a black t-shirt is not visible while in profile view (e.g., side view). The black color of the t-shirt is detectable based on its profile image.

The steps discussed above apply to a query image sent by a device such as 110 of FIG. 1, which may be a mobile device. In order to recommend clothing based on the user's wardrobe, recommendations may be selected from an inventory of clothing of various styles, such as clothing in an ecommerce marketplace. In some embodiments, each clothing item in the inventory may contain meta-data along with attributes associated with it such as price, brand, style, and wearing occasion in addition to other information such as location and description. The user may be requested to select an attribute to be used for clothing recommendations. This dimension may be used to filter items in the inventory. For example, if the user selects medium priced items as the attribute, only medium priced (based on a predetermined metric) items in the inventory may be compared against the user's wardrobe attributes extracted from the corresponding wardrobe query image. Any clothing that has common colors with the color signature extracted from the query image may be retrieved, e.g., the weighted color histogram discussed above with respect to FIG. 3. Such clothing items from inventory may be sorted based on degree of overlap with the color signature. The same color histogram technique may be used to extract the color signature of inventory items (e.g., using images of the inventory items) as for the query image. Optionally, pattern signature may be used along with the color signature.

The search based on the query image may be extended to recommend complementary clothing. For example, if blue jeans were detected in the wardrobe, then clothing that go well with blue jeans may be recommended. In this case, the retrieved items may not have common colors with the wardrobe. Both the functional property as well as color may be used for complementary recommendations. For example, blue jean is not formal clothing. The degree of saturation of blue indicates how casual the situation may be. Lighter blue jeans, as in heavy stone-washed jeans, look more casual than a pair of dark blue jeans. A red T-shirt is better than a red shirt to be paired with light blue jeans. Another example would be recommendation of formal shoes, if it is determined from the query image that a big portion of the wardrobe contains formal clothing. However, if the user prefers diversity, then casual clothing may be recommended based on color preferences as indicated by the wardrobe.

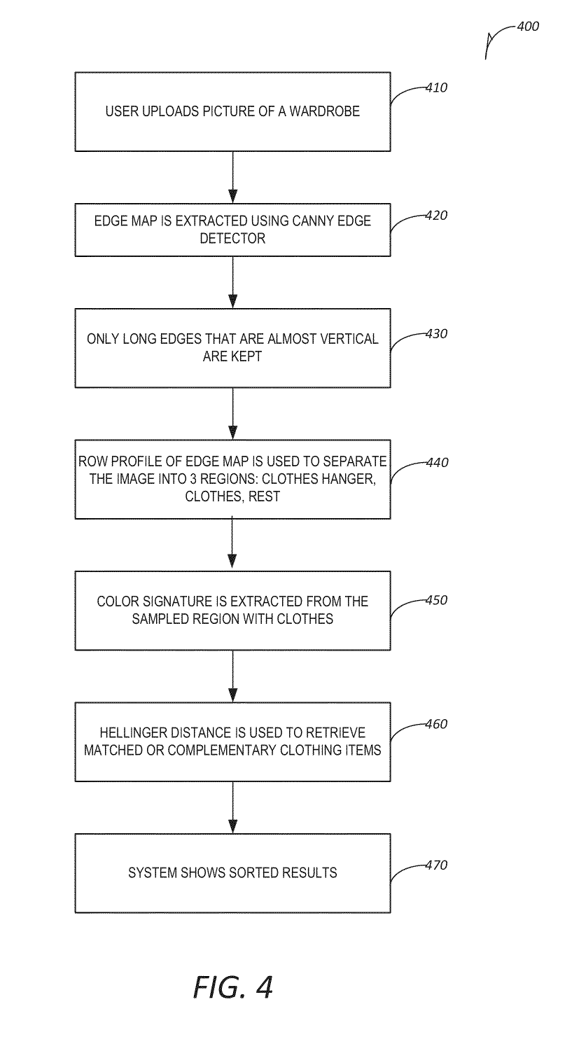

With respect to FIG. 4, the user may interact with the networked system 102 via a client device 110 of FIG. 1. At 410 the user uploads a color picture from a client device, here referred to as an image, of a wardrobe that the user may have taken with a mobile device, the picture showing the content of his/her wardrobe as in the images in the first column 300 of FIG. 3. For example, the panoramic mode on a smart phone may be used to take a photo or picture of a closet content. The networked system determines the colors (and also patterns) of the wardrobe content. The system may further determine clothing styles, to the extent possible, based on the profile or side view of the hanging clothes (e.g., coats, jackets, jeans, shirts, etc.). Based on the wardrobe attributes identified, the system may, for example, additionally determine color distribution of the user's wardrobe, predominance or absence of patterns, which patterns are preferred, lack of formalwear, predominance of skirts over pants, predominance of dresses over pants, proportion of work clothes, exercise clothes, casual clothes, and the like. Based on determined color, pattern, and style information extracted from the image, system recommends matching, complementary, and/or diversity items in the marketplace inventory to the user. As an example, if the user has numerous shirts in various shades of blue, system may recommend a shirt in a shade of blue that the user does not have. Continuing with FIG. 4, an edge map of the image may be extracted as at 420 as discussed with respect to FIG. 3. In one example, a Canny edge detector may be used for this function as discussed above. Using a rule discussed above, at 420 the long edges that are almost vertical may be kept as at 430. At 440 the row profile of the edge map is used to separate the image into three regions, the clothes hangers, the close, and the rest, as discussed with respect to column 302 of FIG. 3. At 450 the color signature is extracted from the sampled region with clothes, as at column 306 of FIG. 3 and at 460 matched or complementary clothing items are detected from the inventory by search, for example. Results may be recommended to the user as at 470.

### Real-Time Recommendations Based on Relevant Visual Context Anchored to a Human Body

In another embodiment, a visual context engine or visual context based recommendation engine (and/or one or more other modules) may be included in the networked system 102 or client machines 110, 112 to perform the functions and operations described below.

Clothing is a non-rigid object. However, when clothing is worn by a human, it can take on a shape or form different from when it is not being worn. The system 100 is configured to interpret clothing information from streaming visual content and to present similar items from the inventory based on the visual content information. A typical use case is when a user is watching a video stream on devices such as a computer, smart phone, digital tablet, or other client device. It is assumed that the clothing is worn by a human in an upright position (e.g., standing or walking). Recommendations may be based on the clothing. An overview of the operations performed is summarized in FIG. 5. FIG. 5 is a flowchart of object detection according to an example embodiment using non-rigid objects such as clothing, perform sampling, and obtain recommendations. These operations may be achieved in a reasonable frame rate so that real-time for near real-time) recommendations may be provided to the user. A video stream 500 of sequential frames may be received by the system. A frame is extracted from the video stream 500 at step 510. Object detection may be performed on different types of objects as at 520. In one embodiment, objects within an image or the video stream 500 (which, as indicated, may be treated as a series of image frames) may be classified as either a rigid object or a non-rigid object. The type of object may dictate how the detection may be performed. Alternatively, one or more different detection schemes may be employed to accurately identify one or more (distinct) objects within a given image/video. In streaming data, maintaining frame rate may be important,

### Rigid Object Detector

With advance in classifiers such as discussed in the paper designated [R2] in the Appendix, rigid objects may be detected from a single image in a short time. This may be more important for streaming data, where maintaining frame rate is important. Examples of rigid objects are cars and computer monitors. Examples of non-rigid objects are clothing and hair/fiber. The human face is somewhat rigid and hence robust detectors such as discussed in the paper designated [R5] in the Appendix may be used. The human torso, especially when upright, is somewhat rigid as well. A survey of pedestrian detectors may be found in the paper designated [R7] in the Appendix.

### Clothing Detection

Clothing may be considered to be a non-rigid object. However, it may be assumed that the human torso (beneath the clothing) is somewhat rigid when the person is upright. The clothing worn, while non-rigid, thus tends to have regions that are rigid. The inner regions of clothing are more rigid than the outer regions. This is obvious for loose clothing such as skirts which is not closely bound to the human body. In some embodiments, rigid object detectors may be used to track the human body, and then sample clothing appropriately from within the tracked human body regions.

### Maintaining Frame Rate

The frame rate of the video stream may be taken into account. Rigid object detectors, although fast, may still affect the frame-rate while processing video stream. This problem may be alleviated by the use of a Graphical Processing Unit (GPU). In general, detection algorithms are more computationally intensive than tracking algorithms. So, for practical purposes, object detection may not need to be performed on every frame of a video stream. Instead, once an object (or group of objects) is detected, it may be tracked for consecutive frames. Since the object is in motion, the lighting conditions, pose, amount of occlusion and noise statistics change. This can result in failure to track the object on some frames. When this happens, object detection may be performed again as at 535 of FIG. 5 until a relevant object is found in a frame. To maintain reasonable frame rate, it may be assumed that only one salient object (or other pre-set small number of objects) is tracked at any given time as at 530 of FIG. 5.

How to Sample from Clothing

As mentioned earlier, clothing is a non-rigid object and it may have a tendency to change shape and form temporally. Coarse object detectors may be fast, and give only an approximate rectangular bounding box around the detected object. Ideally, one could segment the object of interest using this bounding box. Full segmentation algorithms may be computationally expensive. A compromise may be achieved by sampling clothing using a rectangle that may be about half the size of the detected rectangle and has the same centroid. This solves two problems: (1) need for robustness to error in size/location estimate of a detected object, and (2) need to locate non-rigid regions of clothing. However, this sampling approach may not be acceptable when the object detector makes large errors (such as a false positive). To mitigate this, some rules on the detected rectangle may be imposed: (1) height of the detected rectangle for a person spans at least 70% of frame height and/or (2) the top of detected rectangle may be located no lower than the top 10% of a frame. These rules are for an example embodiment and may be adapted depending on the input video stream. In one example, the first few frames of a video stream may be used to learn the statistics of location and size of detected rectangles, which may be then used to establish a threshold or baseline for the subsequent frames of the video stream.

### Recommendations of Similar Clothing

Once a rectangular sample from clothing is detected, useful information may be extracted from it so that it may be used to retrieve similar items from the inventory. Color distribution contains rich information about clothing, as discussed with respect to FIG. 3, and as discussed in U.S. patent application Ser. No. 13/631,848 referenced above. It is reasonable to assume that the video stream is in color. The above U.S. Patent Application discusses an approach that may be used to extract information about color distribution. This is compared against the inventory using the system mentioned above and in that patent application, which in response returns similar items as at 550 of FIG. 5. The results are then presented to the user as at 560 of FIG. 5.

### Smoothing Out Recommendations

As mentioned earlier, due to change in lighting conditions, pose, amount of occlusion and noise statistics, the color distribution may change from frame to frame, even for the same clothing. This may result in unstable recommendations. Information across multiple consecutive frames, for the same object being tracked, may be accumulated and the average response may be used to retrieve similar items. Choice of features discussed in the above patent application allows for averaging seamlessly across a plurality of consecutive frames.

### Presenting Highlights of Streaming Content

The recommendations may be presented to the user in real-time or near real-time) relative to the detected objects that serve as the query input. Because video streams tend to be long (compared to presentation of a single image, for example), the user may be focused on the streaming content most of the time, instead of the recommendations. Having a summary of streaming content along with the corresponding recommendations may be compiled at one place. Highlights of the content may be obtained based on the onset of detection of an object and continued tracking for a sufficient number of frames (say for 5 seconds at full frame rate).

### Worker Thread

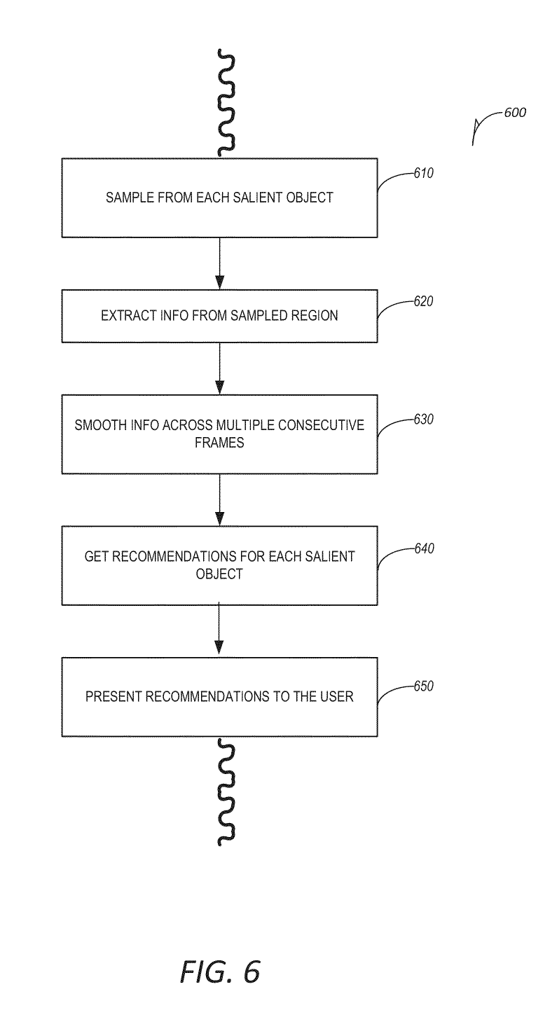

The recommendation results may be presented in real-time (or near real-time) while the user is watching the stream. Recommendations may be typically obtained from a remote server. In one embodiment this may take about 100 ms for a large inventory. Frame rates of 25-30 frames per second may be typical. This means that it may take about 30-40 seconds to process a frame. This is sufficient for the object detection and tracking described. So, in operation, sample clothing, average across multiple contiguous frames, get recommendations and display recommendations, all may be accomplished in a single worker thread. The main thread takes care of extracting frames, detecting salient object(s) and tracking it. This is summarized in FIG. 6 which is a flowchart of a worker thread according to an example embodiment. For example, each salient Object is sampled at 610 and information is extracted from a sampled region at 620 and information across multiple frames may be smoothed as at 630. At 640 recommendations are obtained for each salient object using the processes discussed above, and recommendations may be presented to the user as at 650. This process in the worker thread may run in parallel with the main thread discussed in respect of FIG. 5, which is responsible for object detection and tracking. In some embodiments, a Histogram of Oriented Gradients (HOG) detector may be used for pedestrian detection as discussed in the paper designated [R3] in the Appendix, and the Continuously Adaptive Mean Shift (CAMShift) algorithm discussed in the paper designated [R1] may be used for tracking. CAMShift may be used since it may be assumed that a single salient object may be tracked at any given time and information from color distribution may be used. OpenCV computer vision library discussed in the paper designated [R6] may be used, which provides GPU implementations for a handful of object detectors. With this approach, a time period of about 17 ms may be used to detect a person on a 360p video stream, thus maintaining the original frame rate.

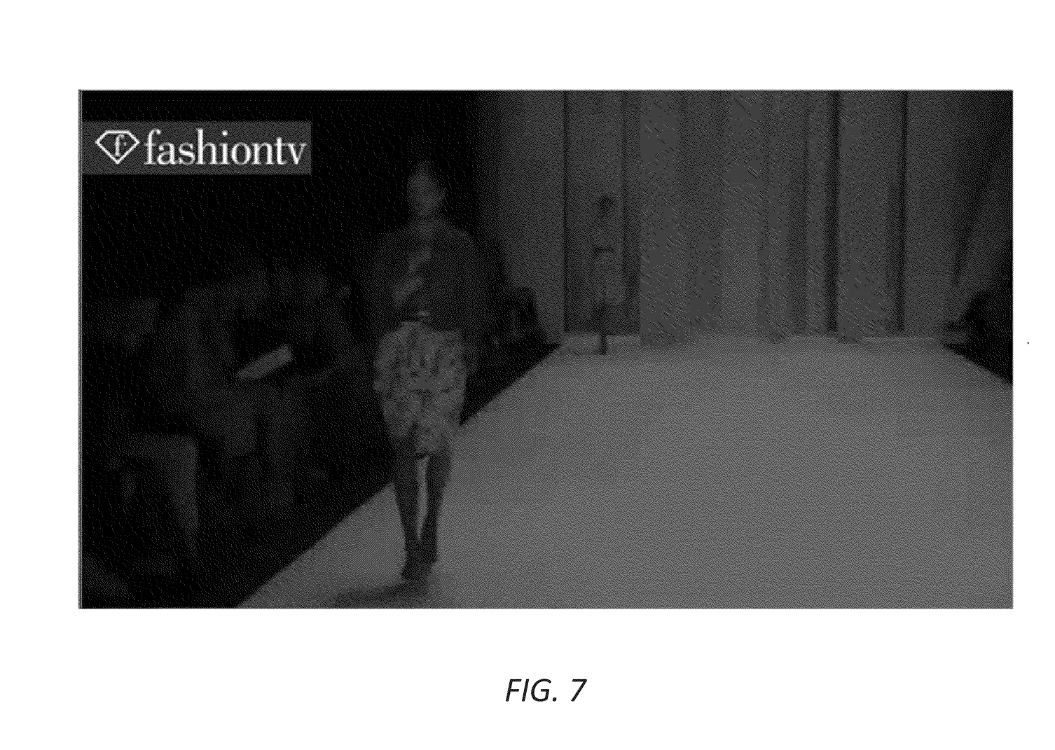

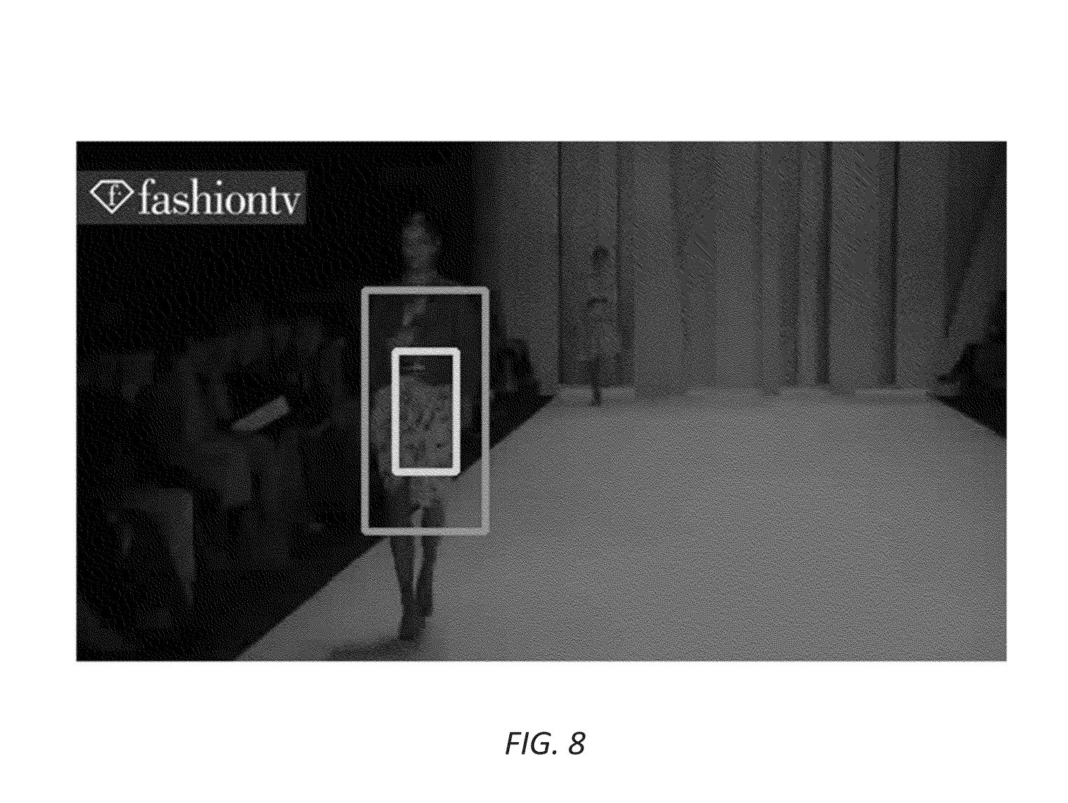

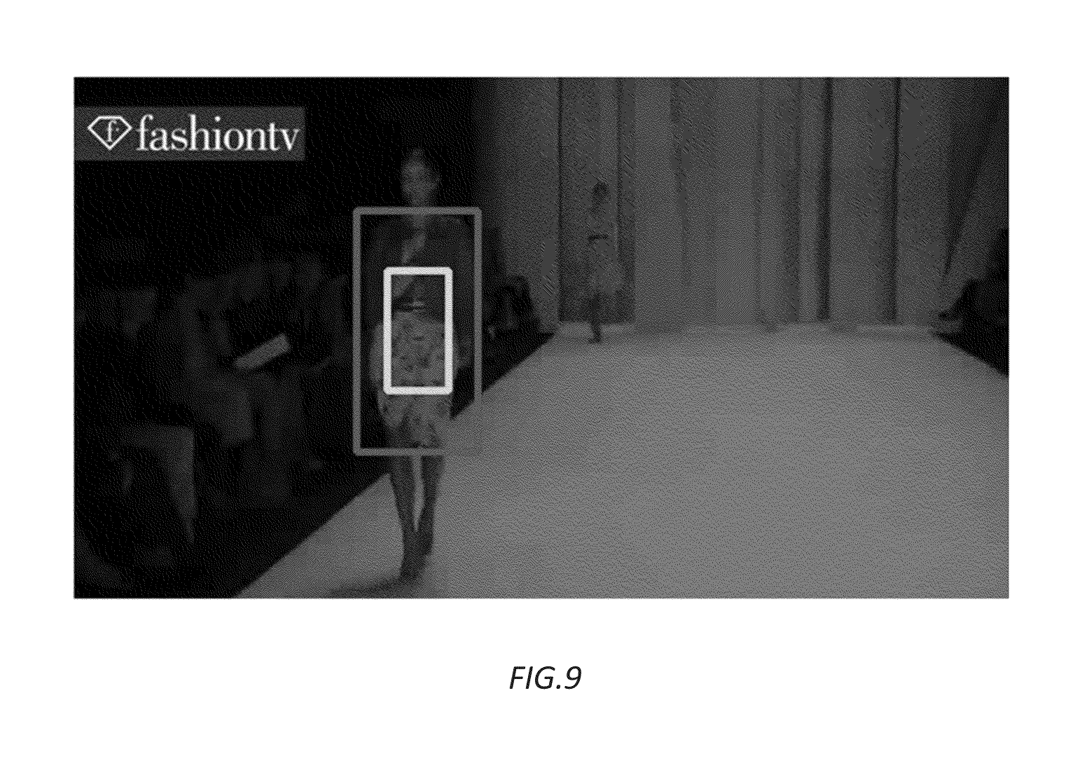

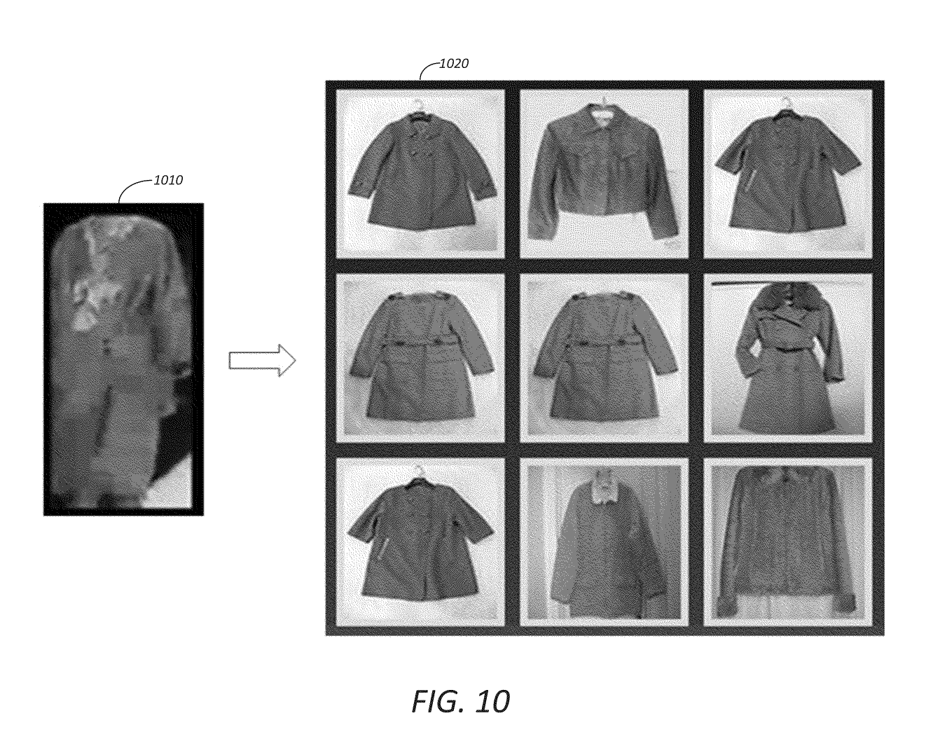

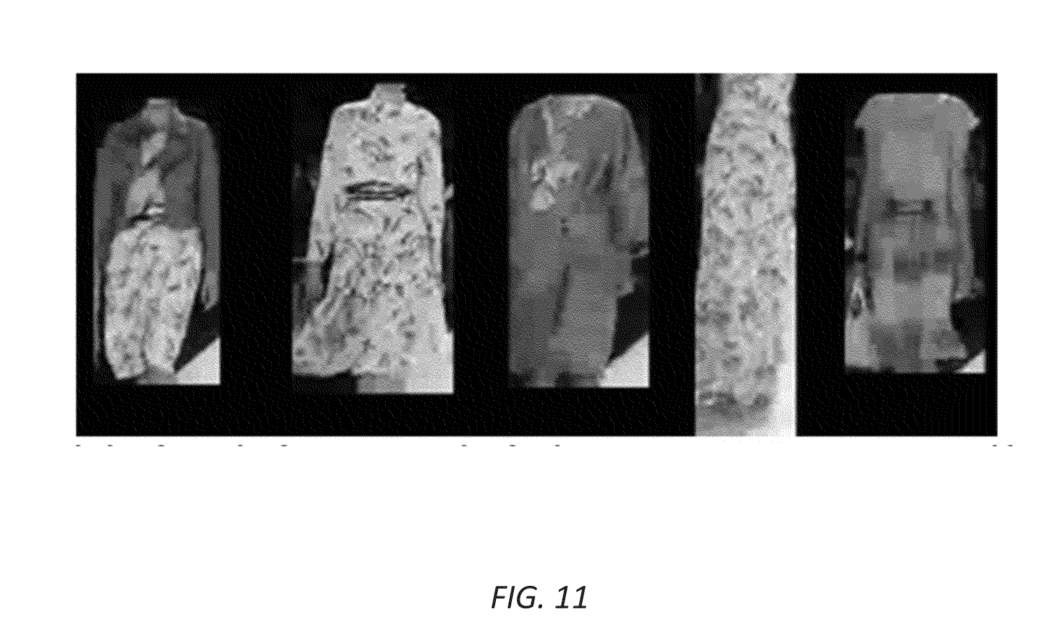

An example is described below that provides recommendations of women's clothing based on video excerpts from New York Fashion Week for Spring 2012. FIG. 7 shows an example of a single frame from a short video. FIG. 8 shows the output of person detection on the first frame at which a person is detected. The sampled rectangular region (the inner rectangle bound box) is also shown. This is the region, or area, that may be used to get the features for recommendations. FIG. 9 shows the next frame, which shows both rectangles tracking well from the previous frame. FIG. 10 shows recommendations for a given sample. For example the brown clothing sample 1010 is used in the process described above and yields the recommendations of brown (in this case matching) clothing 1020. FIG. 11 shows highlights of the video for the first 30 seconds of the video. Highlights behave like bookmarks, where they link to the occurrence of the item in the video, how long it is shown, as well as the recommendations from the inventory.

Real-time (or near real-time) recommendations based on video may also take into account one or more of the following elements:
1) Partition and classify type of clothing and then recommend based on style. For example, the sampled rectangle may be divided into top and bottom halves. Color distribution from each half may be compared to see if they are from the same distribution (within certain limits). If so, the clothing is assumed to be a dress. Otherwise, separate recommendations may be given for each half (example: tops & blouses vs. skirts).
2) Track multiple objects and give recommendations for each detected object. For example, track the face and recommend sun glasses and also track the torso to recommend clothing (e.g., top, dress, jacket).
3) Other objects such as shoes, handbags, or accessories can also be detected and tracked, as long as they are anchored to a track-able human.
4) Detect and track objects not necessarily attached to or associated with the human body (example: furniture).

In this manner, a system may be configured to automatically determine an item of interest in a video and provide matching and/or complementary recommendations based on the automatically determined item of interest. A user provides a video, such as of a model on a catwalk. The system may be configured to parse and track the face, torso, limbs, or other parts of the model's body throughout the video so that the clothing and/or accessories shown by the model may be accurately identified. System finds matching and/or complementary recommendations to the clothing and/or accessories in the video. Such recommendations may be presented to the user in real-time or near real-time.

### Recommendations Based on Celebrity Inspired Fashion/Style

In another embodiment, a recommendation engine (and/or one or more other modules) may be included in the networked system 102 or client machines 110, 112 to perform the functions and operations described below. Recommendations may be made based on styles of celebrities. Wardrobes of celebrities may be built virtually based on photos of celebrities wearing different outfits. Color signature may be extracted from this virtual wardrobe and indexed. Color signature from the query image from the client device may be matched against color signatures of virtual wardrobes. Each virtual wardrobe may be linked to relevant items in the inventory based on visual as well as other information associated with the clothing of celebrities. For example, the relevant items may, in one embodiment, be clothing that is similar to clothing worn by celebrities. These items may be retrieved based on relevance. Stated another way, a unique social component of fashion is inspiration. People generally tend to wear fashion items inspired from an occasion, theme, or even surroundings among many other contexts. One such popular context may be celebrity inspiration—wearing fashion items that match a particular celebrity's style. For instance, given a black and white polka dot top, what kind of skirt would a celebrity, say, Paris Hilton, like to wear with it? This premise may be used to provide a real-time (or near real-time) recommendation system for fashion items that are inspired by celebrity fashion.

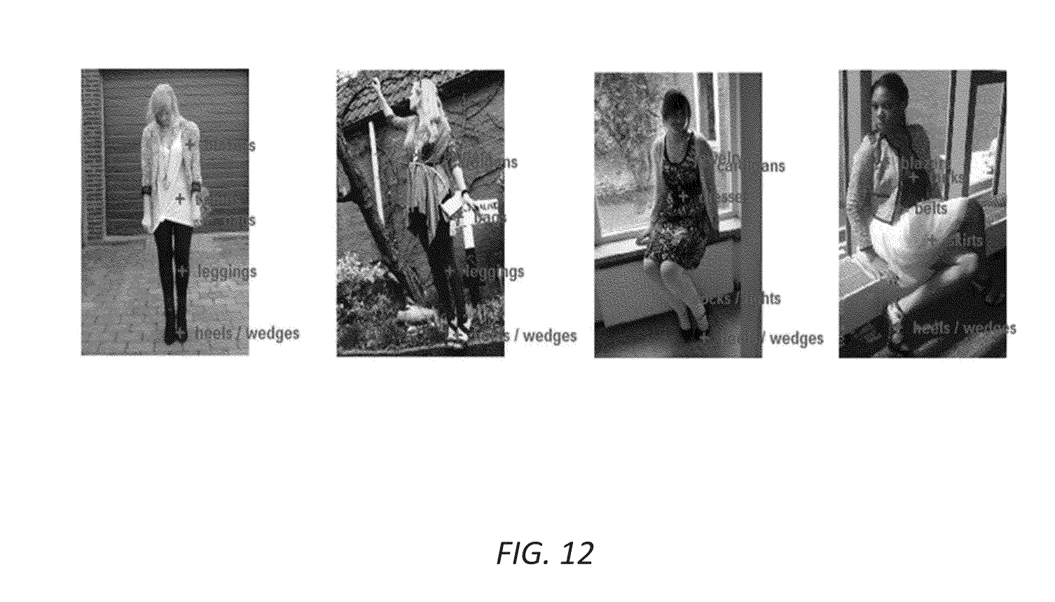

The proposed recommendation system may be divided into three phases:
(1) Data Pre-processing—This phase involves tagging each fashion item in an image at its appropriate location. FIG. 12 shows a few examples where items such as blazers, heels, shirts, and bags may be tagged at their respective location. The tagging may be performed manually (e.g., human annotation) or automatically (e.g., automated framework using computer on algorithms).
(2) Offline Model Training—The task in this phase is to learn representative models for each celebrity automatically. The input to this phase may be a set of tagged images per celebrity from the previous phase. The output of this phase may be a trained model per celebrity.
(3) Online Fashion Recommendation—The task in this phase is to recommend fashion items in an online manner to users based on trained celebrity models from the previous phase. Typically, users select a query fashion item and pick a celebrity; the proposed system loads the corresponding trained celebrity fashion model and uses it to recommend fashion items that may be the best match with the query fashion item.

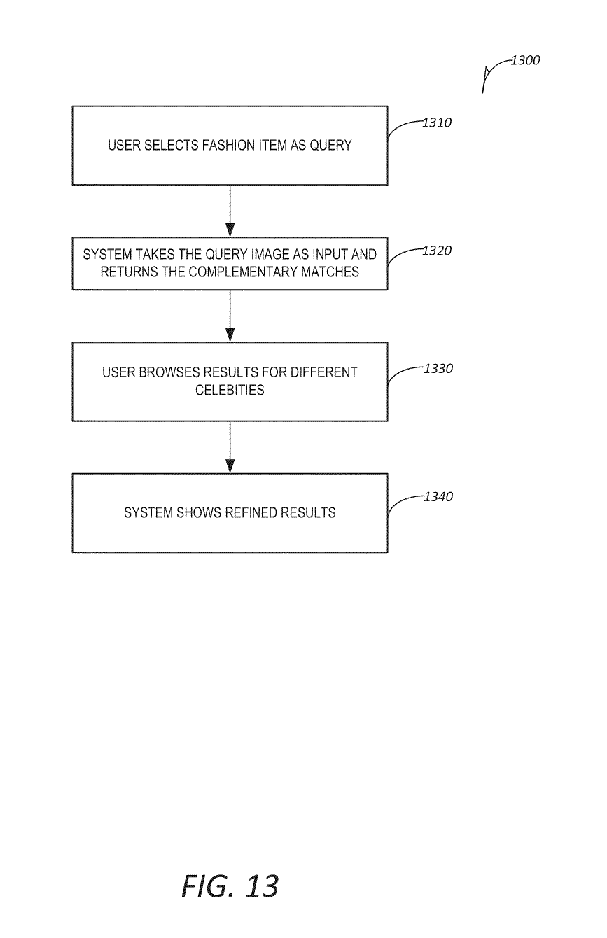

FIG. 13 is a flow chart for providing celebrity inspired recommendations according to an example embodiment. At 1310 a user may be asked to select a particular fashion item as a query and upload a query image, or may upload the image on the user's own volition. At 1320 the system may take the query image as input, performs the color processes described above, and returns complementary, or in some embodiments, matching, matches to the user. At 1330 the user browses results for different celebrities. The system may illustrate refined results to the user as at 1340.

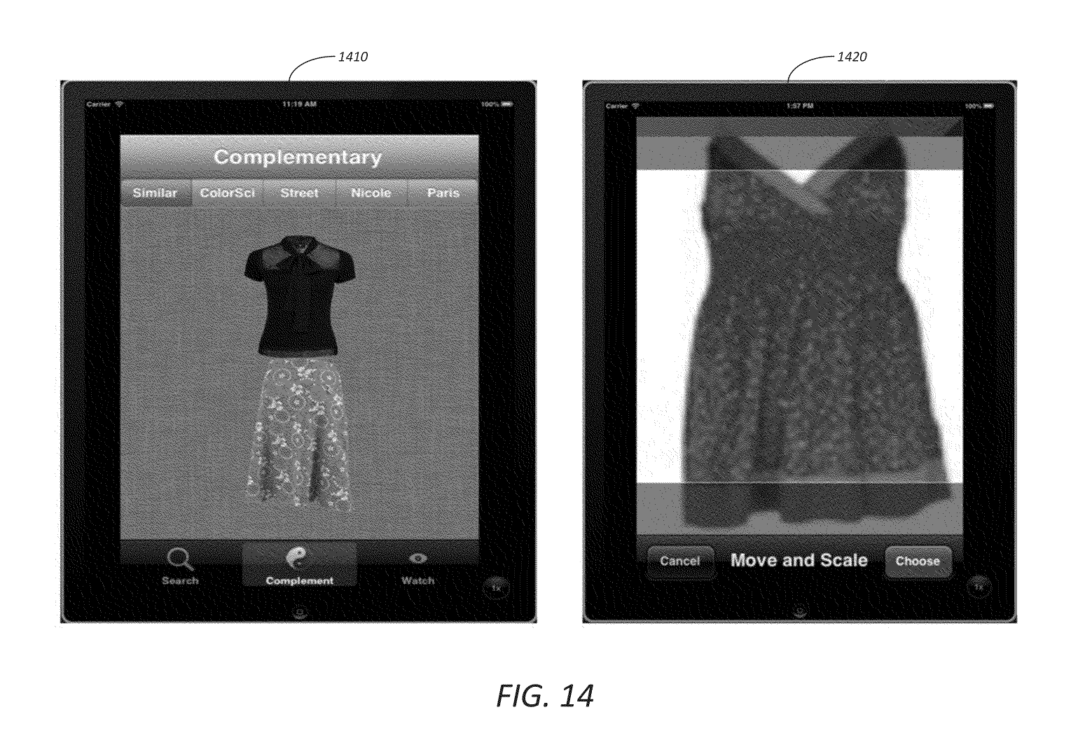

FIG. 14 is an illustration of screen shots for enabling users to browse results for different celebrities according to an example embodiment. In one embodiment, 1410 may be considered a default screen. At 1410 the query has not yet been picked or selected. The “Similar” tab is selected. An example top and skirt are shown at 1410. If the user desires to provide a query for a top he/she may tap the top. For a skirt query, he/she may tap on the skirt. After tapping on the desired clothing, the user is requested to load an input query image. In this example, the user selected a query for the top clothing, which is shown at 1420 FIG. 14.

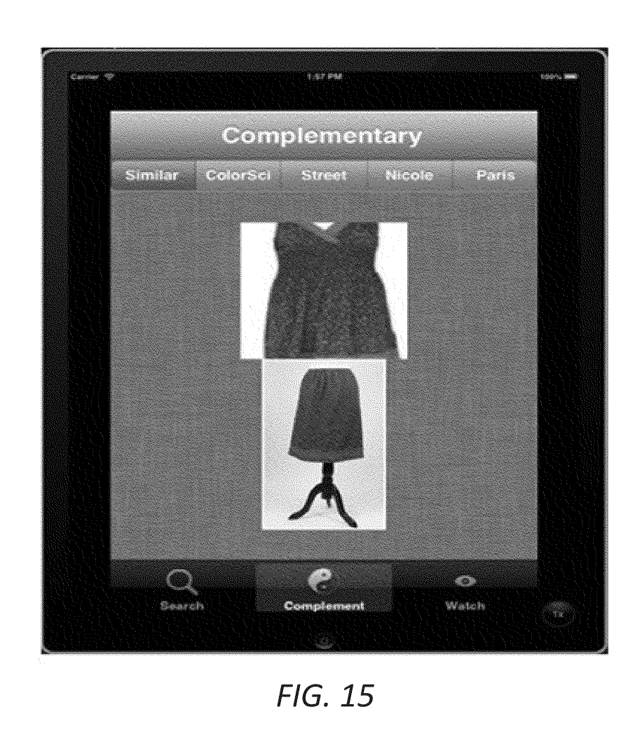

FIG. 15 is an illustration of a retrieved result for a selected top. In this embodiment the “Similar” tab is selected. Since there was no exact match of patterns, the closest match is returned. In this case, the closest match contains mainly blue color with a pattern at the bottom.

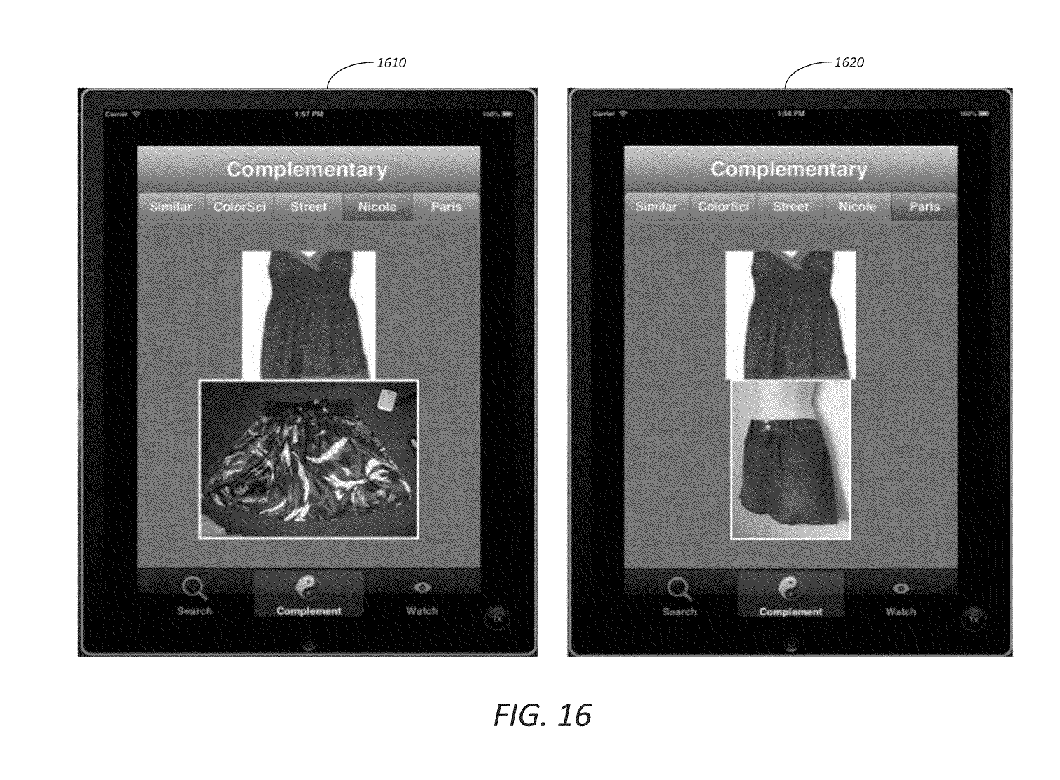

FIG. 16 is an illustration of a user interface for browsing recommendations for a first celebrity according to an example embodiment.

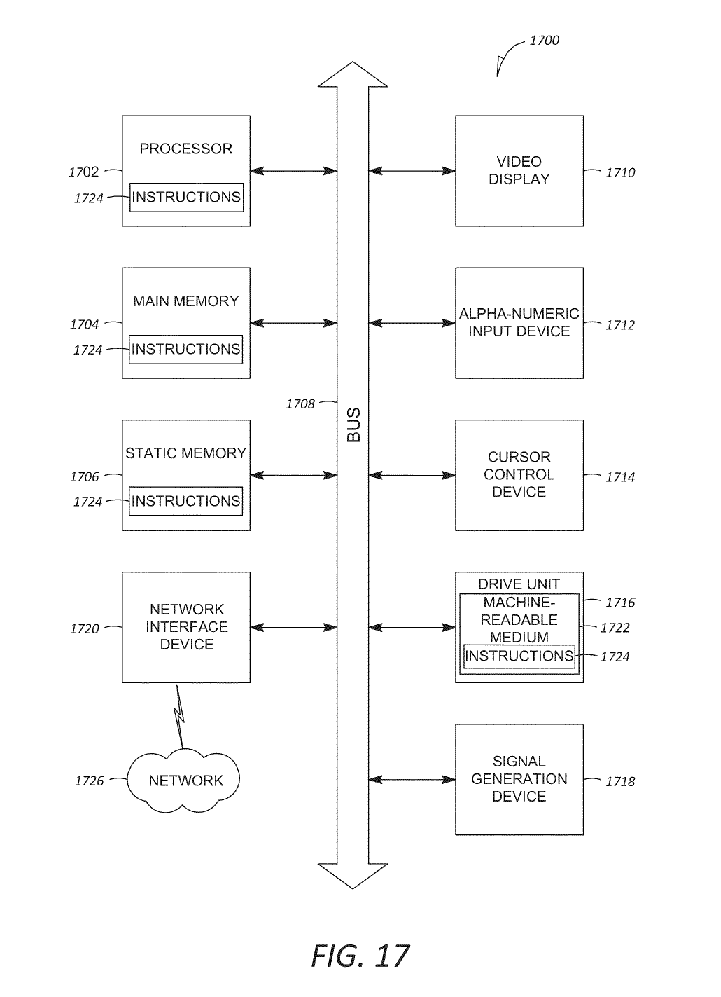

FIG. 17 shows a diagrammatic representation of a machine in the example form of a computer system 1700 within which a set of instructions, for causing the machine to perform any one or more of the methodologies discussed herein, may be executed. The computer system 1700 comprises, for example, any of the device machine 110, device machine 112, applications servers 118, API server 114, web server 116, database servers 124, or third party server 130. In alternative embodiments, the machine operates as a standalone device or may be connected (e.g., networked) to other machines. In a networked deployment, the machine may operate in the capacity of a server or a device machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU), or both), a main memory 1704 and a static memory 1706, which communicate with each other via a bus 1708. The computer system 1700 may further include a video display unit 1710 (e.g., liquid crystal display (LCD), organic light emitting diode (OLED), touch screen, or a cathode ray tube (CRT)). The computer system 1700 also includes an alphanumeric input device 1712 (e.g., a physical or virtual keyboard), a cursor control device 1714 (e.g., a mouse, a touch screen, a touchpad, a trackball, a trackpad), a disk drive unit 1716, a signal generation device 1718 (e.g., a speaker) and a network interface device 1720.

The disk drive unit 1716 includes a machine-readable medium 1722 on which is stored one or more sets of instructions 1724 (e.g., software) any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

The instructions 1724 may further be transmitted or received over a network 1726 via the network interface device 1720.

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the scope of the invention.

The Abstract is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment fbr the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### APPENDIX

[R1] G. R. Bradski, “Computer vision face tracking for use in a perceptual user interface”, Intel Tech Journal Q2, 1998.
[R2] P. A. Viola, M. J. Jones, “Rapid Object Detection using a Boosted Cascade of Simple Features”, IEEE Conference on Computer Vision and Pattern Recognition (CVPR), pp. 511-518, 2001.
[R3] N. Dalai, B. Triggs, “Histograms of Oriented Gradients for Human Detection”, International Conference on Computer Vision & Pattern Recognition (CVPR), vol. 2, pp. 886-893, June 2005.
[R4] A. Yilmaz, O. Javed, M. Shah, “Object Tracking: A Survey”, ACM Journal of Computing Surveys, vol. 38, no. 4, December 2006.
[R5] C. Huang, H. Ai, Y. Li, S. Lao, “High-Performance rotation invariant multi-view face detection”, IEEE Transactions on Pattern Analysis and Machine Intelligence (PAMI), vol. 29, issue 4, pp. 671-686, 2007.
[R6] G. Bradski, A. Koehler, “Learning OpenCV”, ISBN 978-0-596-51613-0, O'Reilly Media Inc., 2008,
[R7] P. Dollar, C. Wojek, B. Schiele, P. Perona, “Pedestrian detection: A benchmark”, IEEE Conference on Computer Vision and Pattern Recognition (CVPR), pp. 304-311, 2009.

What is provisionally claimed is:

1. A computer implemented method for providing fashion recommendations comprising:
receiving, from a client device, a query image representing an image of clothing;
processing the query image to identify at least one of color, pattern, and style information corresponding to at least one characteristic of the clothing in the image of clothing;
using the identified at least one of color, pattern, and style information to search an online inventory of clothing to find relevant clothing in the online inventory to recommend via a user interface.

2. The method of claim 1, wherein identifying the color comprises using a hue, saturation and value color space with a plurality of bins for each of the hue axis, the saturation axis, and the value axis, and a separate bin for pixels of a predetermined saturation.

3. The method of claim 1 wherein the processing comprises at least one of boundary detection, sampling, and color segmentation.

4. The method of claim 3 wherein the sampling comprises sampling swatches from the image of clothing, the clothing situated in a wardrobe, the method further comprising filtering out background information.

5. The method of claim 1 wherein the query image comprises a video in which the image of clothing comprises clothing on a human body,
the method further comprising
sampling an area of the clothing on the human body, and
detecting and tracking the area of the clothing on the human body across sequential frames of the video to obtain the at least one of color, pattern, and style information.

6. The method of claim 5 wherein an body is in motion.

7. The method of claim 3, the method further comprising receiving from the client device the identity of a celebrity, and the relevant clothing comprises clothing that is associated with clothing of the celebrity.

8. The method of claim 3 wherein the relevant clothing is one of matching clothing or complementary clothing to the clothing in the image of clothing.

9. One or more computer-readable hardware storage device having embedded therein a set of instructions which, when executed by one or more processors of a computer, causes the computer to execute operations comprising:
receiving a query image comprising content representing an image of clothing;
processing the query image to identify, at least one of color, pattern, and style information corresponding to at least one characteristic of the clothing in the image of clothing;
using the identified at least one of color, pattern, and style information to search an online inventory of clothing to find relevant clothing in the online inventory to recommend via a user interface.

10. The one or more computer-readable hardware storage device of claim 9, wherein identifying the color comprises using a hue, saturation and value color space with a plurality of bins for each of the hue axis, the saturation axis, and the value axis, and a separate bin for pixels of less than a predetermined saturation.

11. The one or more computer-readable hardware storage device of claim 10 wherein the processing comprises at least one of boundary detection, sampling, and color segmentation.

12. The one or more computer-readable hardware storage device of claim 11 wherein the sampling comprises sampling swatches from the image of clothing, the clothing situated in a wardrobe, the operations further comprising filtering out background information.

13. The one or more computer-readable hardware storage device of claim 10 wherein the query image comprises a video and the image of clothing comprises clothing on a human body, the operations further comprising
sampling an area of the clothing on the human body,
detecting and tracking the area of the clothing on the human body across sequential frames of the video to obtain the at least one of color, pattern, and style information,
comparing the at least one of color, pattern, and style information against clothing in the online inventory to find the relevant clothing in the online inventory.

14. The one or more computer-readable hardware storage device of claim 10, the operations further comprising receiving the identity of a celebrity, and the relevant clothing comprises clothing that is associated with clothing of the celebrity.

15. The one or more computer-readable hardware storage device of claim 10 wherein the relevant clothing is one of matching clothing or complementary clothing to the clothing of the image of clothing.

16. A system for providing fashion recommendations comprising:
one or more computer processors configured to
receive from a client device, a query image that comprises content representing an image of clothing;
process the query image to identify at least one of color, pattern, and style information that corresponds to at least one characteristic of the clothing in the image of clothing;
use the identified at least one of color, pattern, and style information to search an online inventory of clothing to find relevant clothing in the online inventory to recommend via a user interface, the color is identified using a hue, saturation and value color space with a plurality of bins for each of the hue axis, the saturation axis, and the value axis, and a separate bin for pixels of a predetermined saturation.

17. The system of claim 16 wherein the processing comprises at least one of boundary detection, sampling, and color segmentation.

18. The system of claim 17 wherein the sampling comprises sampling swatches from the image of clothing, the clothing is situated in a wardrobe, the one or more computer processors further configured to filter out background information.

19. The system of claim 16, the image of clothing comprises a video that includes clothing on a human body in motion,
the one or more computer processors further configured to
sample an area of the clothing on the human body,
detect and track the area of clothing on the human body across sequential frames of the video to obtain at least one of color, pattern, and style information, and
compare the at least one of color, pattern, and style information against clothing in the online inventory to find the relevant clothing in the online inventory.

20. The system of claim 18, the one or more computer processors further configured to receive from the client device the identity of a celebrity, and the relevant clothing comprises clothing that is associated with clothing of the celebrity.
